(19) United States
(12) Patent Application Publication
(10) Pub. No.: US 2025/0331000 A1
(43) Pub. Date: Oct. 23, 2025

(54) RESOURCE SELECTION FOR NR SIDELINK COMMUNICATIONS

(71) Applicant: Apple Inc., Cupertino, CA (US)

(72) Inventors: Huaning Niu, San Jose, CA (US); Weidong Yang, San Diego, CA (US); Wei Zeng, Saratoga, CA (US); Chunxuan Ye, San Diego, CA (US); Sigen Ye, San Diego, CA (US); Hong He, San Jose, CA (US); Dawei Zhang, Saratoga, CA (US); Oghenekome Oteri, San Diego, CA (US); Yushu Zhang, Beijing (CN)

(21) Appl. No.: 18/860,644

(22) PCT Filed: Apr. 1, 2023
(86) PCT No.: PCT/US2023/017222

§ 371 Date: Oct. 26, 2024

Related U.S. Application Data
(60) Provisional application No. 63/335,888, filed on Apr. 28, 2022.

(51) Int. Cl. H04W 72/25; H04L 5/00; H04W 28/02; H04W 72/115

(52) U.S. Cl. CPC H04W 72/25; H04L 5/0055; H04L 5/0098; H04W 28/0278; H04W 72/115

(57) ABSTRACT

Techniques, described herein, include solutions for enabling sidelink resource selection in an unlicensed spectrum. A first UE may receive a configured grant from a base station for specified sidelink resources. Additionally, or alternatively, a base station may have informed the UE of a pool of potential sidelink resources, and the UE may select suitable sidelink resources from the pool of resources. The UE may perform a listen-before-talk (LBT), clear channel assessment (CCA), or another type of sensing procedure to verify the availability of the selected resources. The UE may inform other UEs and/or the base station of the sidelink resource selection and use the sidelink resources for sidelink communications with another UE.

### REFERENCE TO RELATED APPLICATION

This Application claims the benefit of U.S. Provisional Application No. 63/335,888, filed on Apr. 28, 2022, the contents of which are hereby incorporated by reference in their entirety.

### FIELD

This disclosure relates to wireless communication networks including techniques for selecting wireless resources for sidelink communications in a wireless communication network.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes enabling user equipment (UE) to communicate directly with one another via sidelink communications.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example overview of sidelink resource selection according to one or more implementations described herein.

FIG. 3 is a diagram of another example overview of sidelink resource selection according to one or more implementations described herein.

FIG. 4 is a diagram of an example of a process for sidelink resource selection according to one or more implementations described herein.

FIGS. 5 and 6 are an example of a process for sidelink resource selection according to one or more implementations described herein.

FIGS. 7 and 8 are an example of a process for sidelink resource selection according to one or more implementations described herein.

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity. In some implementations, UEs may be capable of communicating and connecting with one another directly. Direct communications between UEs may be referred to as device-to-device (D2D) communications, vehicle-to-anything (V2X) communications, sidelink communications, and so on. UEs may use one or more wireless frequency bands to communicate with different wireless devices. For example, a UE may use a licensed frequency band to communicate with a base station and a non-licensed frequency band to communicate with other UEs. UEs may engage in a resource selection procedure (e.g., sidelink resource selection) to enable direct communication with other UEs.

Sidelink resource selection, as described herein, may include mode 1 sidelink resource selection and mode 2 sidelink resource selection. Mode 1 sidelink resource selection may include a dynamic grant scheduling and a configured grant scheduling of sidelink resources managed by a base station or other network device. Dynamic grant scheduling may include a one-time sidelink resource being scheduled for transmission. Configured grant scheduling may include a set of sidelink resources being scheduled for transmission. Implementations described herein as including or involving a configured grant scheduling may also, or alternative, involve dynamic grant scheduling. In a mode 1 scenario, the network dynamically allocates sidelink resources to UEs for sidelink communications. Further, mode 1 sidelink resource selection may include a type 1 configured grant or a type 2 configured grant. A type 1 configured grant may include a base station using radio resource control (RRC) signaling to indicate one or more wireless carriers or channels, a periodicity of allocated resources, an offset, start, and length of resources (e.g., symbols), a number of repetitions, a transmission power level, etc. A type 2 configured grant may include a base station providing a more limited amount of configured grant information via RRC (e.g., a periodicity and number of repetitions) and providing additional sidelink configured grant information via downlink control information (DCI). The configured grant may include DCI with a sidelink radio network temporary identifier (SL-RNTI), a sidelink configured scheduling (CS) RNTI (SL-CS-RNTI), etc. By contrast to the network-managed sidelink resource selection of mode 1, mode 2 sidelink resource selection may include resource selection largely performed by the UE. For example, in mode 2 sidelink resource selection, a base station may provide UE with a pool of potential sidelink resources, and the UE may perform the sensing (e.g., availability detection), selection, and reservation of the sidelink resources among the pool of potential sidelink resources.

However, currently available sidelink resource selection or allocation techniques fail to provide a complete or adequate solution to sidelink resource selection and reservation. For example, prior to using sidelink resources in the unlicensed spectrum, a UE may be configured to perform a listen-before-talk (LBT) procedure, clear channel assessment (CCA), etc., to ensure that the sidelink resources are not already being used (e.g., by another UE). Currently available sidelink resource allocation techniques fail to account for the UE performing the LBT, CCA and therefore may result in the UE selecting inadequate sidelink resources that for example, may not properly synchronize with the UE performing the LBT, CCA, etc.

Accordingly, the techniques described herein provide a superior and more complete solution for sidelink resource selection in the unlicensed spectrum by accounting for the UE assessing sidelink resource availability prior to use. For example, a UE may use the licensed spectrum or unlicensed Uu link to send a request for sidelink resource to a base station. The request may be for sidelink resources in the unlicensed spectrum and/or may include a scheduling request (SR) and/or buffer status report (BSR). The base station may allocate sidelink resources via a dynamic grant, or via a configured grant, which may be a type 1 configured grant. Alternatively, the base station may have previously provided the UE with a pool of sidelink resource from which the UE may select, which may be a type 2 configured grant. sidelink resources, as described herein, may include time and frequency resources that UEs may use for uni-directional or bi-directional communication with another UE via a physical sidelink control channel (PSCCH) and/or physical sidelink shared channel (PSSCH).

In some implementations, the dynamic grant or configured grant may also indicate a clear channel assessment (CCA) procedure associated with the sidelink resources, which may include an indication of a CCA type (e.g., a type 1 CCA, a type 2 CCA, etc.), a priority class for the CCA, a starting position for the sidelink resources, etc. A CCA procedure may include a process by which a user devices measures an amount of radio activity (e.g., a signal-to-noise ratio (SNR) corresponding to a particular carrier, set of carriers, or channel. The UE may determine whether the channel or resource is available based on whether the measured activity meets a pre-selected threshold. The dynamic grant/configured grant may also, or alternatively, indicate whether the sidelink resources correspond to a partial bandwidth (BW) or a full (BW), a corresponding starting point, etc.

The UE may respond to the configured grant by performing a CCA procedure in accordance with the configured grant. After a successful CCA procedure, the UE may proceed to use the sidelink resources to communicate with a target UE. For example, the UE may send and receive data via sidelink, perform a hybrid automatic repeat request (HARQ) procedure, etc., for a duration of the channel occupation time (COT). In some implementations, the UE may also, or alternatively, notify the base station and other UEs in the area the sidelink resources that have been allocated to the UE. Reporting the sidelink resource allocation to the base station and other UEs may facilitate appropriate sidelink grants to other UEs by confirming which sidelink resources are already being used and therefore unavailable. The UE and the base station may also, or alternatively, engage in further sidelink resource grants (e.g., in response to a non-acknowledgement (NACK) message) by repeating one or more of the configured grant operations discussed above. Accordingly, the techniques described herein provide an enhanced and more complete solution for allocating sidelink resources in the unlicensed spectrum by ensuring that sidelink resource selection and reservation appropriately account for configured grants, resource monitoring procedures (e.g., LBT, CCA, etc.), resource reservation (e.g., informing other devices of sidelink resource usage), etc.

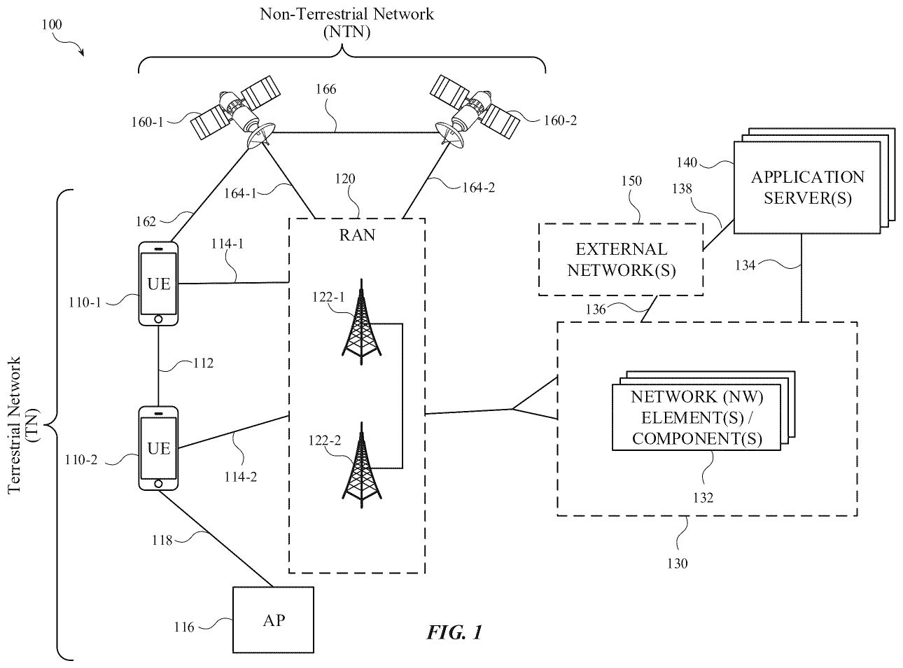

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe), device-to-device (D2D) communications, or vehicle-to-everything (V2X) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, a V2X connection, etc. In some implementations, UEs 110 may be configured to discover one another, negotiate wireless resources between one another, and establish connections between one another, without intervention or communications involving base station 122 or another type of network node. In some implementations, discovery, authentication, resource negotiation, registration, etc., may involve communications with base station 122 or another type of network node.

UEs 110 may use one or more wireless channels 112 to communicate with another. As described herein, UE 110-1, may comprise one or more processors configured to: communicate, to base station 122 via a first frequency band, a request for sidelink resource selection in a second frequency band; receive, from the base station and in response to the request, a dynamic grant or configured grant regarding sidelink resources; perform a clear channel assessment (CCA) procedure based on the dynamic grant or configured grant; select sidelink resources based on the CCA procedure and the dynamic grant or configured grant; and communicate with another UE 110-2 based on the sidelink resources. The first frequency band is a licensed frequency band and the second frequency band is an unlicensed frequency band.

UEs 110 may communicate and establish a connection with (e.g., be communicatively coupled) with RAN 120, which may involve one or more wireless channels 114-1 and 114-2, each of which may comprise a physical communications interface/layer. As shown, UE 110 may also, or alternatively, connect to access point (AP) 116 via connection interface 118, which may include an air interface enabling UE 110 to communicatively couple with the AP 116. The AP 116 may comprise a wireless local area network (WLAN), WLAN node, WLAN termination point, etc.

RAN 120 may include one or more base stations 122-1 and 122-2 (referred to collectively as base stations 122, and individually as base station 122) that enable channels 114-1 and 114-2 to be established between UEs 110 and RAN 120. As examples therefore, a base station 122 may be an E-UTRAN Node B (e.g., an enhanced Node B, eNodeB, eNB, 4G base station, etc.), a next generation base station (e.g., a 5G base station, NR base station, next generation eNBs (gNB), etc.). The base stations 122 may include a roadside unit (RSU), a transmission reception point (TRxP or TRP), and one or more other types of ground stations (e.g., terrestrial access points). In some scenarios, the base station 122 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 160 may operate as bases stations 122 with respect to UEs 110. As such, references herein to a base station 122 may involve implementations where the base station 122 is a terrestrial network node and also to implementation where the base station 122 is a non-terrestrial network node (e.g., satellite 160).

In some implementations, a downlink resource grid may be used for downlink transmissions from any of the base stations 122 to UEs 110, and uplink transmissions may utilize similar techniques. The grid may be a time-frequency grid (e.g., a resource grid or time-frequency resource grid) that represents the physical resource for downlink in each slot. In some aspects, the duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, base stations 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the base stations 122 may operate using licensed assisted access (LAA), eLAA, and/or feLAA mechanisms. In these implementations, UEs 110 and the base stations 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

As shown, RAN 120 may be connected (e.g., communicatively coupled) to a core network (CN) 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations 122 with respect to UEs 110. As such, references herein to a base station 122 may involve implementations where the base station 122 is a terrestrial network node and implementation, where the base station 122 is a non-terrestrial network node (e.g., satellite 160). As described herein, UE 110 and base station 122 may communicate with one another, via interface 114, to enable enhanced power saving techniques.

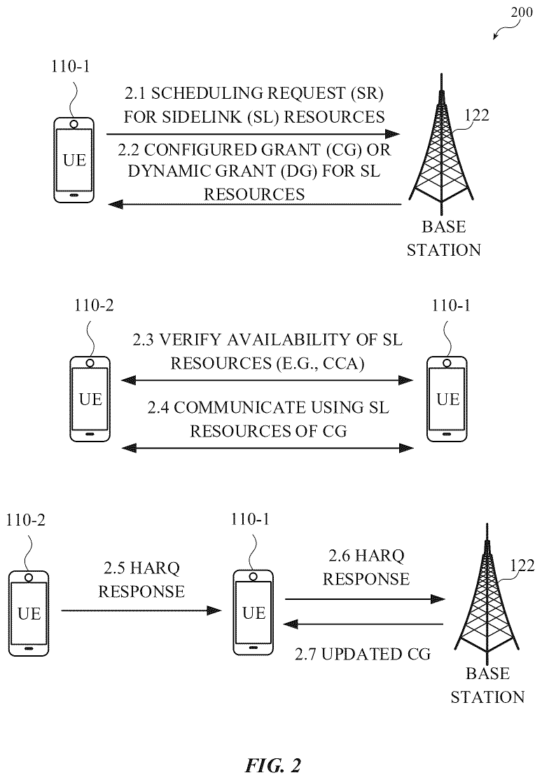

FIG. 2 is a diagram of an example overview 200 of sidelink resource selection according to one or more implementations described herein. Example overview 200 may correspond to a dynamic sidelink resource selection and allocation scenario (e.g., a configured grant type mode 1 scenario, where base station 122 manages sidelink resource selection). For purposes of explaining FIG. 2, assume that UE 110-1 has already performed sidelink discovery, authentication, and link-establishment with another UE (e.g., UE 110-2).

As shown, UE 110-1 may send an SR to base station 122 for sidelink resources (at 2.1). UE 110-1 may send the SR using a licensed spectrum and the SR may be a request for sidelink resources in an unlicensed spectrum. In response to the SR, base station 122 may determine sidelink resources suitable for UE 110-1 to engage in sidelink communications, which may be based on one or more of a variety of factors or conditions, such as sidelink resources currently allocated to other UEs 110, a BSR received with the SR, capabilities of UE 110-1, sidelink congestion recently reported by one or more UEs 110, etc. Upon determining suitable sidelink resources, base station 122 may respond to the request by providing a configured grant to UE 110 (at 2.2).

As the configured grant may pertain to unlicensed spectrum resources, the configured grant may prompt UE 110-1 to verify an availability of the allocated resources. As such, UE 110-1 and/or UE 110-2 may perform a LBT procedure, CCA procedure, or another type of assessment to determine the availability of the sidelink resources allocated by base station 122 (at 2.3). Upon determining that the allocated sidelink resources are available, UE 110-1 may proceed by using the sidelink resources to communicate with UE 110-2 (at 2.4). The configured grant may enable uni-directional or bi-directional communication between UE 110-1 and UE 110-2 (e.g., via a PSCCH and/or PSSCH). Uni-directional communication may include information being provided from one device to another (e.g., from UE 110-1 to UE 110-2). Bi-directional communication may include information being provided between devices (e.g., to and from both UE 110-1 and UE 110-2).

UE 110-1 and UE 110-2 may implement HARQ protocols to help verify successful and unsuccessful transmissions. As shown for example, UE 110-2 may communicate a HARQ response to UE 110-1 (at 2.5), and UE 110-1 may send or otherwise notify base station 122 of the HARQ response (at 2.6). Doing so may enable UE 110-1 to notify base station 122 that the allocated sidelink resources are being used and also notify base station 122 whether the sidelink resources are being used successfully (e.g., based on an acknowledgement (ACK) or non-acknowledgement (NACK) message forwarded to base station 122). Base station 122 may receive the HARQ response, determine whether to update the configured grant of sidelink resources, and may provide UE 110-1 with an updated configured grant accordingly (e.g., so that UE 110-1 may retransmit information that was not acknowledged by UE 110-2) (at 2.7).

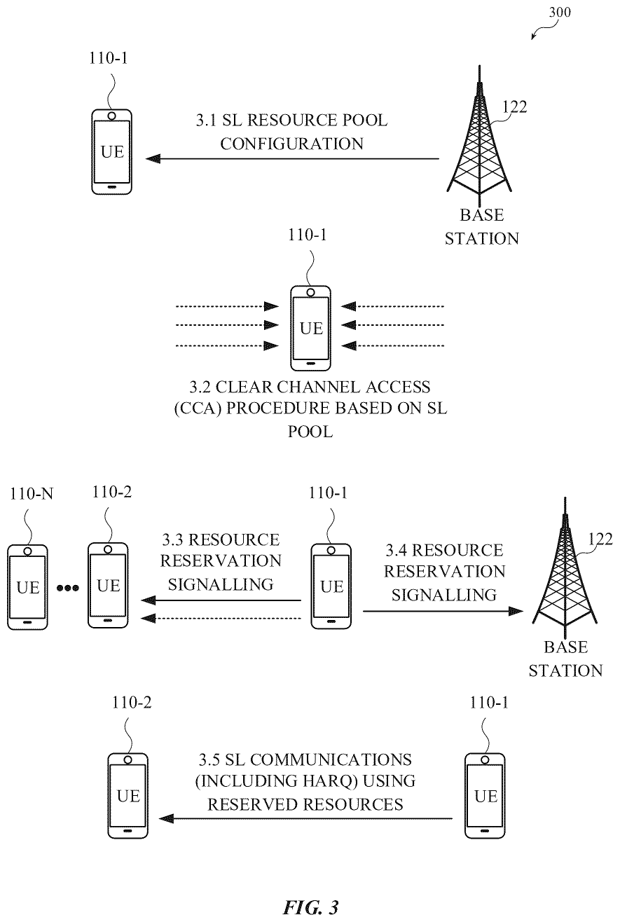

FIG. 3 is a diagram of another example overview 300 of sidelink resource selection according to one or more implementations described herein. Example overview 300 may correspond to a resource pool sidelink resource selection and allocation scenario.

As shown, UE 110-1 may receive sidelink resource pool configuration information from base station 122 (at 3.1). The sidelink resource pool information may include a range of possible sidelink resources that UE 110-1 may use to communicate with other UEs 110 via sidelink. As such, to identify and reserve sidelink resources, UE 110-1 may verify an availability of sidelink resources from the sidelink pool by performing a LBT procedure, a CCA procedure, or one or more other types of resource availability verification procedures (at 3.2). In response to successfully determining that one or more sidelink resources (e.g., sidelink carriers, sidelink channels, etc.) are available, UE 110-1 may communicate resource reservation information to other UEs in the area (e.g., UE 110-2 through UE 110-N) (at 3.3). Additionally, or alternatively, UE 110-1 may provide base station 122 with the resource reservation information (at 3.4). The resource reservation information may describe the sidelink resources (e.g., carriers, channels, periodicities, number of repetitions, etc.) that UE 110-1 is to use for sidelink communications. Providing resource reservation information to other devices may enhance sidelink resources selection throughout the network as base stations 122 or other UEs 110 may become aware of sidelink resources that are not available. As shown, UE 110-1 may use the reserved resources to communicate with UE 110-2 via sidelink communication (at 3.5). The sidelink communications may include the implementation of HARQ procedures to, for example, enable UE 110-1 to verify that sidelink communications are successful, retransmit information when appropriate, and trigger reselection and reservation of alternative sidelink resources when desirable.

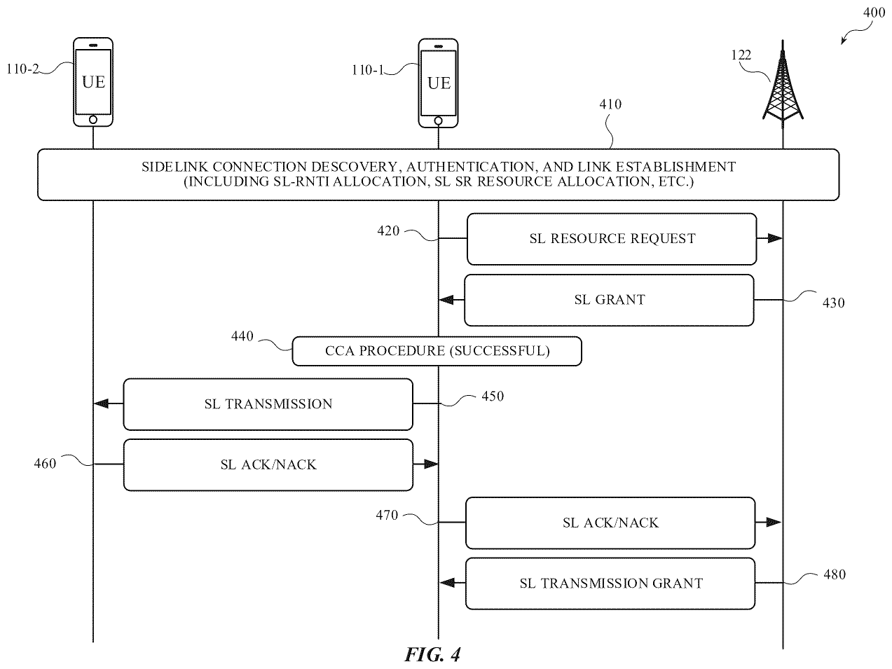

FIG. 4 is a diagram of an example of a process 400 for sidelink resource selection according to one or more implementations described herein. Process 400 may be implemented by UE 110 and base station 122. In some implementations, some or all of process 400 may be performed by one or more other systems or devices, including one or more of the devices of FIG. 1. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or process depicted in FIG. 4.

As shown, process 400 may include sidelink connection discovery, authentication, and link establishment (at 410). In some implementations, this may include SL-RNTI allocation, SL-SR resource allocation, etc. As such, process 400 may begin after UE 110-1 and UE 110-2 have already discovered one another, been authenticated for sidelink communications, and established a link with one another. A remainder of process 400 may address a scenario in which UE 110-1 is to continue communicating with UE 110-2 and sidelink resource selection allocation operations are therefore performed.

As shown for example, UE 110-1 may send a sidelink resource request to base station 122 (at 420). In some implementations, the sidelink resource request may include a SR for sidelink resources and/or a corresponding BSR. In some implementations, the sidelink resource request may be sent to base station 122 via a licensed spectrum. In some implementations, the sidelink resource request may be sent to base station 122 via an unlicensed spectrum. In such scenarios, the sidelink resource request may be sent during a COT initiated by base station 122 or UE 110-1. The COT may correspond to duration that is to include the sidelink resource request, a sidelink grant, and usage of the sidelink resources of the sidelink grant (e.g., for communications with another UE 110-2). In some implementations, UE 110 may use a type 1 channel access procedure for a physical random access channel (PRACH) transmission that includes a SR and/or BSR. The transmission may not include user plane data and may correspond to a particular priority class (e.g., priority class 1).

In some implementations, the SR sent by UE 110-1 to base station 122 may be dedicated, or otherwise configured, for mode 1 type sidelink configured grant procedures (e.g., dynamically scheduled configured grant procedures managed by the network). For example, the SR sent by UE 110-1 may include a data set, one or more parameters, etc., that identify the SR as being for mode 1 type sidelink configured grants. Implementing an SR that is specifically configured to mode 1 scenarios may facilitate differentiation from other types of SRs (e.g., SRs that are not for dynamic sidelink resource requests and allocations). In implementations where UE 110-1 is not configured to send an SR dedicated for mode 1 type sidelink configured grant procedures, UE 110-1 may use (e.g., trigger) a random access procedure to report that the SR is for a mode 1 type sidelink configured grant. For example, UE 110-1 may use a MsgA and/or Msg3 of a PRACH to indicate that an SR is for a mode 1 type sidelink configured grant procedure.

Base station 122 may receive the SR from UE 110-1, determine one or more sidelink resources suitable for enabling UE 110-1 to engage in, or continue engaging in, sidelink communications, and may provide UE 110-1 with a corresponding sidelink grant (at 430). The sidelink grant may be a configured grant for sidelink resources and may include a type 1 configured grant or a type 2 configured grant. In some implementations, the sidelink grant may indicate a CCA type. This may include a 1-bit indication in the sidelink grant. When the sidelink grant indicates a type 1 CCA procedure, UE 110-1 may respond by determining a priority class for the CCA procedure. Alternatively, when the sidelink grant indicates a type 1 CCA and a corresponding priority class. The CCA type and the priority class may include a 2-bit indication (e.g., 1 bit for the CCA type and 1 bit for the priority class). The priority class may be based on BSR information and/or the BSR logic channel. For example, a BSR indicating time-sensitive information (e.g., streaming data, real-time data, VolP communications, etc.) may cause a higher level of priority to be assigned to the CCA procedure. In some implementations, the CCA type may not be indicated by base station 122 but instead determined by UE 110-1 (e.g., based on the nature of the sidelink communications, BSR information, etc.).

CCA type 1 may be a full CCA procedure. The procedure may include the following steps: 1) set N=Nᵢₙᵢₜ, where Nᵢₙᵢₜ may be a random number uniformly distributed between 0 and CWₚ, and go to step 4; 2) if N>0 and the sidelink UE may choose to decrement the counter (e.g., set Set N=N−1); 3) sense the channel for an additional sensing slot duration, and if the additional sensing slot duration is idle, go to step 4; else, go to step 5; 4) if N=0, stop; else, go to step 2. 5) sense the channel until either a busy sensing slot is detected within an additional defer duration T_{d} or all the sensing slots of the additional defer duration T_{d} may be detected to be idle; 6) if the channel is sensed to be idle during all the sensing slot durations of the additional defer duration T_{d}, go to step 4; else, go to step 5; The defer duration T_{d} may consist of duration T_{f}=16 us immediately followed by mₚ consecutive sensing slot durations Tₛₗ, and T_{f} includes an idle sensing slot duration Tₛₗ at start of T_{f}. CW_{min,p} less than or equal to CWₚ, which is less than or equal to CW_{max,p}, is the contention window. CWₘᵢₙ and CWₘₐₓ and corresponding priority may have two options as indicated by the following tables.

| Channel | | | | | |
|---|---|---|---|---|---|
| Access | | | | | |
| Priority | | | | | Allowed CWₚ |
| Class (p) | mₚ | CW_{min, p} | CW_{max, p} | T_{mcot, p} | Sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

| Channel | | | | | |
|---|---|---|---|---|---|
| Access | | | | | |
| Priority | | | | | Allowed CWₚ |
| Class (p) | mₚ | CW_{min, p} | CW_{max, p} | T_{mcot, p} | Sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms, it may be increased to 8 ms by inserting one or more gaps. The minimum duration of a gap shall be 100 us. The maximum duration before including any such gap shall be 6 ms.

Type 2 channel access may be a one-shot LBT. Type 2A Sidelink UE channel access procedure: If a sidelink UE is indicated to perform Type 2A sidelink channel access procedures, the sidelink UE may use Type 2A sidelink channel access procedures for a sidelink transmission. The sidelink UE may transmit the transmission immediately after sensing the channel to be idle for at least a sensing interval, T_{short_ul} 25 us. T_{short_ul} may consists of a duration T_{f}=16 us immediately followed by one slot sensing slot and T_{f} includes a sensing slot at start of T_{f}. The channel is considered to be idle for T_{short_ul} if both sensing slots of T_{short_ul} are sensed to be idle.

Type 2B sidelink channel access procedure: If a sidelink UE is indicated to perform Type 2B sidelink channel access procedures, the sidelink UE may use a Type 2B sidelink channel access procedure for a sidelink transmission. The UE may transmit the transmission immediately after sensing the channel to be idle within a duration of T_{f}=16 us. T_{f} may include a sensing slot that occurs within the last 9 us of T_{f}. The channel may be considered to be idle within the duration T_{f} if the channel is sensed to be idle for total of at least 5 us with at least 4 us of sensing occurring in the sensing slot. Type 2C sidelink channel access procedure. If a sidelink UE is indicated to perform Type 2C sidelink channel access procedures for a sidelink transmission, the sidelink UE may not sense the channel before the transmission. The duration of the corresponding sidelink transmission may be, at most, 584 us.

In some implementations, base station 122 may indicate whether the sidelink grant corresponds to a partial bandwidth (BW) or full BW allocation. A starting point for partial BW scenarios may be configured (e.g., made explicit). A partial BW scenario may involve a frequency division multiplexing (FDM) situation, where multiple sidelink transmissions are to be appropriately structured and aligned so as to avoid one UE starting a sidelink transmission prematurely and blocking other FDM transmissions. The manner in which sidelink transmissions are coordinated and synchronized may be referred to as an interlace structure. For a full BW scenario, a 20 megahertz (MHz) BW may be allocated to one UE 110 with a 10/5 interlacing structure for 15/30 kilohertz (kHz), respectively. UE 110-1 may select a random starting position within a first symbol of the full BW and use cyclic prefix (CP) extension to fill in any remaining, partial, or half symbol. In some implementations, base station 122 may also, or alternatively, identify a set of starting positions, notify UE 110-1 of the set, and UE 110-1 may select a starting symbol from the set of starting positions. In some implementations, UE 110-1 may do so upon successful completion of a LBT procedure, CCA procedure, etc.

UE 110-1 may perform a CCA procedure (at 440). The CCA procedure may satisfy a requirement for wireless devices (e.g., UEs) to verify that unlicensed spectrum resources are available (e.g., via LBT, CCA, signal-to-noise measurement, and/or one or more other or additional resource monitoring procedure. For purposes of explaining FIG. 4, assume that the CCA procedure is successful (e.g., that UE 110-1 determines that the sidelink grant resources are available for use). UE 110-1 may proceed to use the sidelink grant to communicate information to UE 110-2 via sidelink transmission (at 450). The communications between UE 110-1 and UE 110-2 may be performed via a PUSCH and/or PSSCH, and a starting position for a transmission may depend on whether a partial BW and/or full BW was allocated via the configured grant (e.g., the sidelink grant). UEs 110-1 and 110-2 may be configured to perform HARQ operations. For example, UE 110-2 may respond to the sidelink transmission from 110-1 by spending an ACK message or NACK message (at 460) depending on whether the sidelink transmission was successfully received. Sidelink HARQ and potential sidelink data may be shared during a COT, and COT sharing information may be provided via the PSCCH between the UEs 110-1 and 110-2.

UE 110-1 may be configured to receive the ACK or NACK message (at 460) and may communicate the ACK or NACK message to base station 122 (at 470). A successful confirmation message (e.g., ACK message) may indicate to UE 110-1 and/or base station 122 (e.g., via a PUCCH of the licensed band) whether the resources of the sidelink grant were successfully used and/or whether additional or alternative sidelink resources may be useful for UE 110-1 and UE 110-2 communications. For example, an ACK message or NACK message may cause base station 122 to provide UE 110-1 with another sidelink transmission grant that may extend the time for which UE 110-1 may use the sidelink grant, provide UE 110-1 with an sidelink grant (e.g., a retransmission grant) that includes additional sidelink resources, an sidelink grant that includes alternative sidelink resource, etc. (at 480).

As such, one or more of the techniques described herein may enable UEs 110 to obtain sidelink configured grants for sidelink resources (e.g., unlicensed spectrum resources, perform a monitoring procedure for using the resources, use the resources according to the configured grant, and implement HARQ procedures to determine/report whether sidelink resources are being successfully used, allocated additional/alternative sidelink resources, etc.).

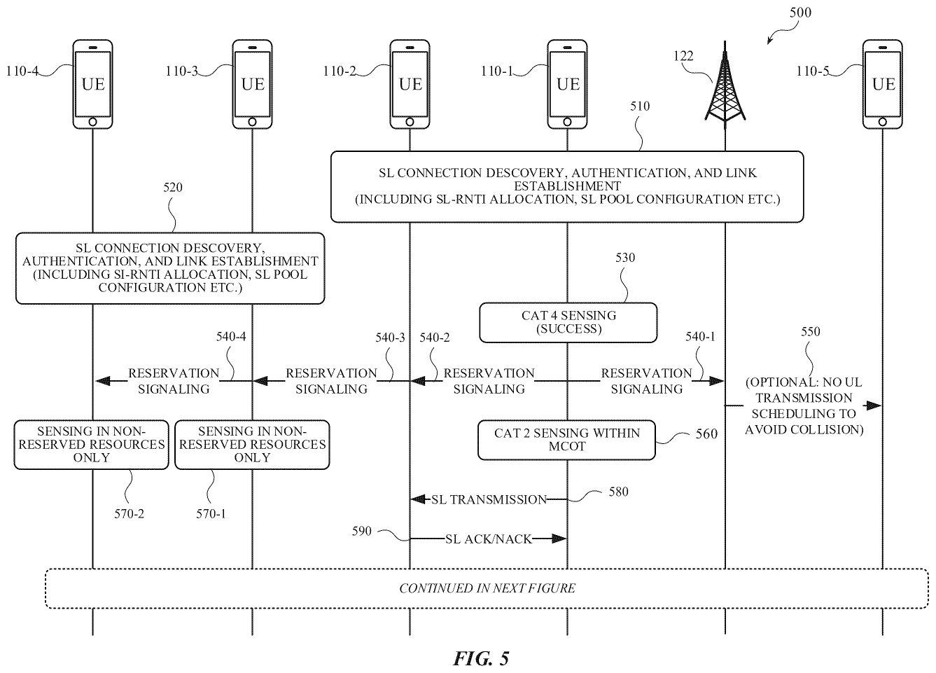

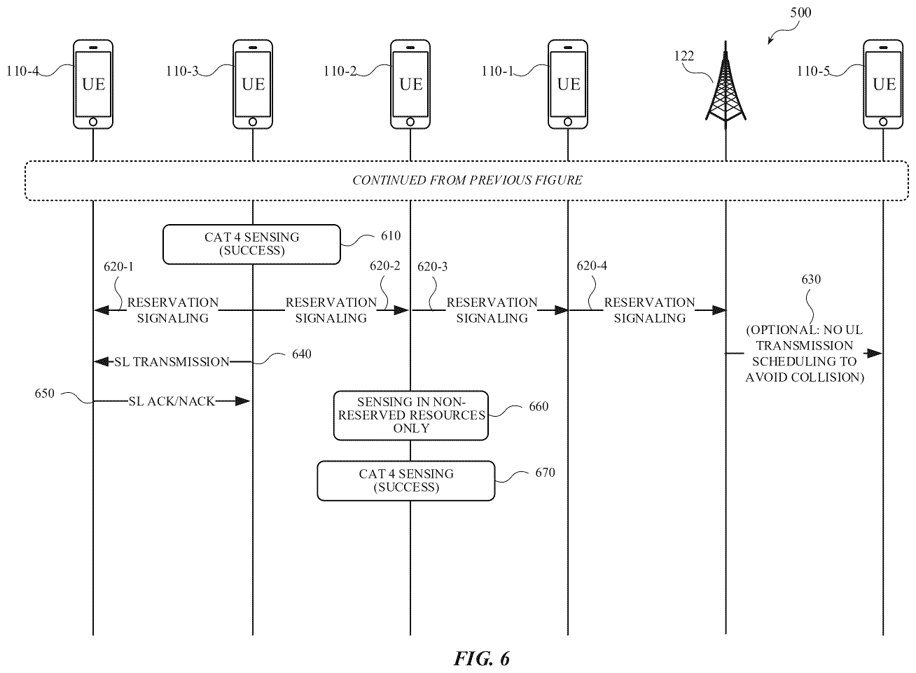

FIGS. 5 and 6 are an example of a process 500 for sidelink resource selection according to one or more implementations described herein. Process 500 may be implemented by UE 110 and base station 122. In some implementations, some or all of process 400 may be performed by one or more other systems or devices, including one or more of the devices of FIG. 1. Additionally, process 500 may include one or more fewer, additional, differently ordered and/or arranged operations than those shown in FIGS. 5 and/or 6. In some implementations, some or all of the operations of process 500 may be performed independently, successively, simultaneously, etc., of one or more of the other operations of process 500. As such, the techniques described herein are not limited to a number, sequence, arrangement, timing, etc., of the operations or process depicted in FIGS. 5 and/or 6.

As shown, process 500 may include sidelink connection discovery, authentication, and link establishment involving UE 110-1, UE 110-2, and base station 122 (at 510). Process 500 may include sidelink connection discovery, authentication, and link establishment involving UE 110-3 and UE 110-4 (at 520). UE 110-1 may select one or more sidelink resources from a pool of sidelink resources previously provided by a network device, such as base station 122. UE 110-1 may perform a category 4 (CAT 4) sensing operation, such as a LBT procedure, CCA procedure, etc., with respect to the selected sidelink resources (at 530). When the CAT 4 sensing operation is successful. UE 110-1 may reserve (via reservation signaling) the corresponding sidelink resources and notify nearby UEs (e.g., UE 110-2, UE 110-3, UE 110-4, etc.) and/or base station 122 that UE 110-1 has reserved the sidelink resources for sidelink communications (at 540-1, 540-2, 540-3, and 540-4). Doing so may notify the UEs 110 and base station 122 that certain resources, of a pool of resources designated by the network for sidelink communications, is now reserved and should therefore not be used by others.

In some implementations, the reservation signaling from UE 110-1 may cause base station 122 to notify other UEs (e.g., UE 110-5) to refrain from sending certain UL transmission scheduling to avoid collisions with the reserved resources (at 550). After the reservation signaling, UE 110-1 may perform category 2 (CAT 2) sensing during a maximum call occupancy time (MCOT) or another period of time corresponding to the reserved sidelink resources (at 560). UEs 110-3 and 110-4 may perform sensing operations (e.g., CAT 4 sensing operations) for non-reserved sidelink resources (e.g., sidelink resources from the pool of sidelink resources that are not currently reserved) (at 570-1 and 570-2). UE 110-1 may communicate an sidelink transmission to UE 110-2 based on the reserved sidelink resources (at 580) and UE 110-2 may respond with a sidelink ACK/NACK message (at 590) depending on whether, for example, the sidelink transmission from UE 110-1 was successfully received.

Referring now to FIG. 6, process 500 my proceed with UE 110-3 performing a CAT 4 sensing operation with respect to the selected sidelink resources (at 630). When the CAT 4 sensing operation is successful. UE 110-3 may reserve (via reservation signaling) the corresponding sidelink resources and notify nearby UEs (e.g., UE 110-1, UE 110-2, UE 110-4, etc.) and/or base station 122 that UE 110-3 has reserved certain sidelink resources for sidelink communications (at 620-1, 620-2, 620-3, and 620-4). Doing so may notify the UEs 110 and base station 122 that certain resources, of a pool of resources designated by the network for sidelink communications, are now reserved and should therefore not be used by others.

In some implementations, the reservation signaling from UE 110-3 may cause base station 122 to notify other UEs (e.g., UE 110-5) to refrain from sending certain UL transmission scheduling to avoid collisions with the reserved resources (at 630). After the reservation signaling, UE 110-3 may communicate an sidelink transmission to UE 110-4 based on the reserved sidelink resources (at 640) and UE 110-4 may respond with an sidelink ACK/NACK message (at 650) depending on whether, for example, the sidelink transmission from UE 110-3 was successfully received.

Process 500 may proceed with UE 110-2 performing sensing operations (e.g., CAT 4 sensing operations) for non-reserved sidelink resources (e.g., sidelink resources from the pool of sidelink resources that are not currently reserved by another UE) (at 670). In response to a successful CAT 4 sensing operation (at 670), UE 110-2 may proceed to select sidelink resources, reserved the sidelink resources, notify other devices of the reservation, etc. (not shown), and process 500 may continue in a similar manner to enable UEs 110 to identify and select available sidelink resources for communicating with one another.

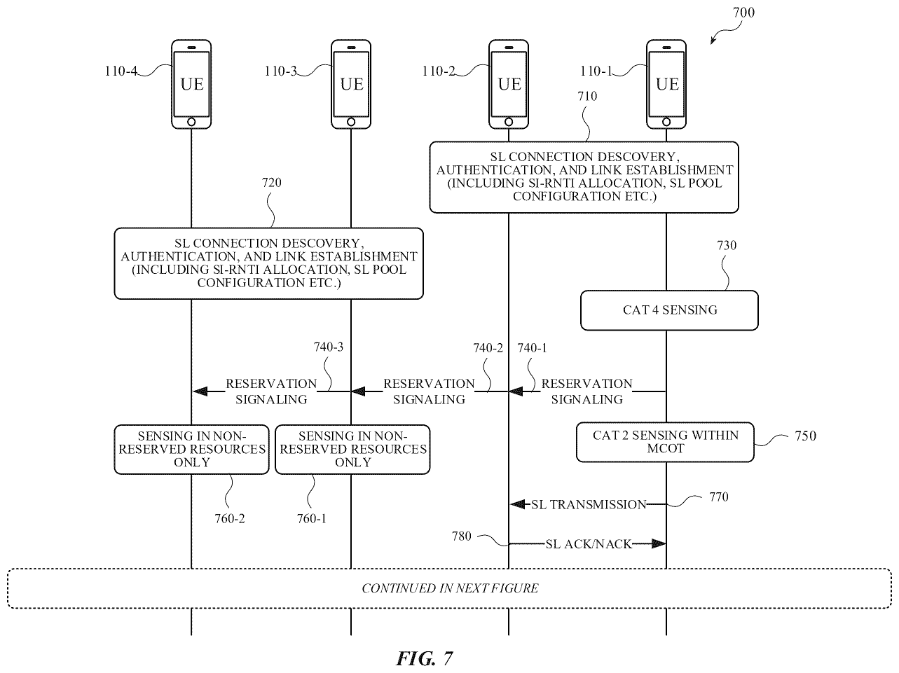

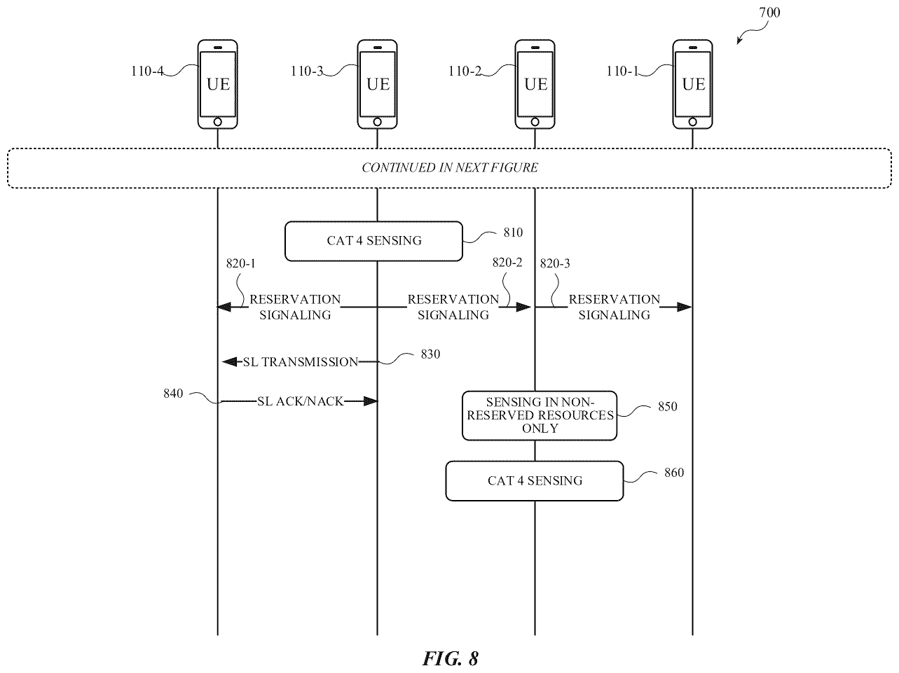

FIGS. 7 and 8 are an example of a process 700 for sidelink resource selection according to one or more implementations described herein. Process 700 may be implemented by UE 110 and base station 122. In some implementations, some or all of process 700 may be performed by one or more other systems or devices, including one or more of the devices of FIG. 1. Additionally, process 700 may include one or more fewer, additional, differently ordered and/or arranged operations than those shown in FIGS. 7 and/or 8. In some implementations, some or all of the operations of process 700 may be performed independently, successively, simultaneously, etc., of one or more of the other operations of process 700. As such, the techniques described herein are not limited to a number, sequence, arrangement, timing, etc., of the operations or process depicted in FIGS. 7 and/or 8.

As shown, process 700 may include sidelink connection discovery, authentication, and link establishment involving UE 110-1 and UE 110-2 (at 710). Process 700 may include sidelink connection discovery, authentication, and link establishment involving UE 110-3 and UE 110-4 (at 720). UE 110-1 may select one or more sidelink resources from a pool of sidelink resources previously provided by a network device, such as base station (not shown). UE 110-1 may perform a category 4 (CAT 4) sensing operation, such as a LBT procedure, CCA procedure, etc., with respect to the selected sidelink resources (at 730). When the CAT 4 sensing operation is successful. UE 110-1 may reserve (via reservation signaling) the corresponding sidelink resources and notify nearby UEs (e.g., UE 110-2, UE 110-3, UE 110-4, etc.) that UE 110-1 has reserved the sidelink resources for sidelink communications (at 740-1, 740-2, and 740-3). Doing so may notify the UEs 110 that certain resources, of a pool of resources designated by the network for sidelink communications, is now reserved and should therefore not be used by others.

After the reservation signaling, UE 110-1 may perform category 2 (CAT 2) sensing during a MCOT, or another period of time corresponding to the reserved sidelink resources (at 750). UEs 110-3 and 110-4 may perform sensing operations (e.g., CAT 4 sensing operations) for non-reserved sidelink resources (e.g., sidelink resources from the pool of sidelink resources that are not currently reserved) (at 760-1 and 760-2). UE 110-1 may communicate an sidelink transmission to UE 110-2 based on the reserved sidelink resources (at 770) and UE 110-2 may respond with a sidelink ACK/NACK message (at 780) depending on whether, for example, the sidelink transmission from UE 110-1 was successfully received.

Referring now to FIG. 8, process 700 may proceed with UE 110-3 performing a CAT 4 sensing operation with respect to the selected sidelink resources (at 810). When the CAT 4 sensing operation is successful, UE 110-3 may reserve (via reservation signaling) the corresponding sidelink resources and notify nearby UEs (e.g., UE 110-1, UE 110-2, UE 110-4, etc.) that UE 110-3 has reserved certain sidelink resources for sidelink communications (at 820-1, 820-2, and 820-3). Doing so may notify the UEs 110 that certain resources, of a pool of resources designated by the network for sidelink communications, is now reserved and should therefore not be used by others. After the reservation signaling, UE 110-3 may communicate an sidelink transmission to UE 110-4 based on the reserved sidelink resources (at 830) and UE 110-4 may respond with a sidelink ACK/NACK message (at 840) depending on whether, for example, the sidelink transmission from UE 110-3 was successfully received.

Process 700 may proceed with UE 110-2 performing sensing operations (e.g., CAT 4 sensing operations) for non-reserved sidelink resources (e.g., sidelink resources from the pool of sidelink resources that are not currently reserved by another UE) (at 850). In response to a successful CAT 4 sensing operation (at 860), UE 110-2 may proceed to select sidelink resources, reserved the sidelink resources, notify other devices of the reservation, etc. (not shown), and process 700 may continue in a similar manner to enable UEs 110 to identify and select available sidelink resources for communicating with one another.

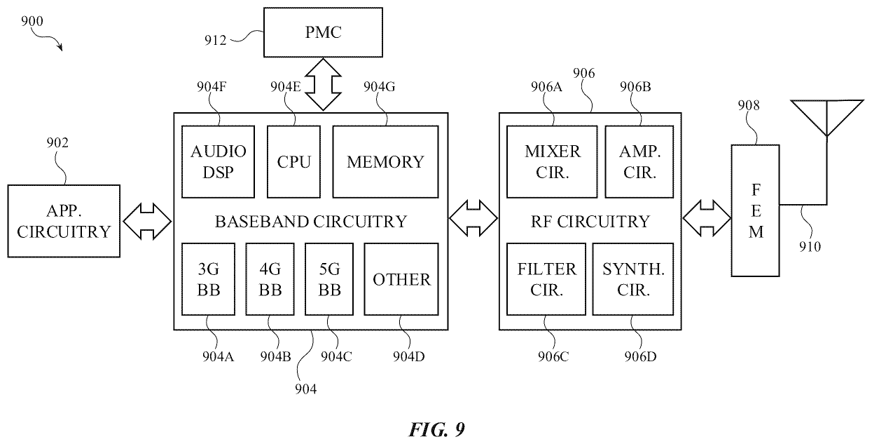

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN such as 5GC 130 or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

UEs 110 may use one or more components of FIG. 9 to perform one or more operations for processes described herein. For example, UE 110 may use application circuitry 902, baseband circuitry 904, RF circuitry 906, front-end module (FEM) circuitry 908, one or more antennas 910, and power management circuitry (PMC) 912 to: communicate, to base station 122 via a first frequency band, a request for sidelink resource selection in a second frequency band; receive, from the base station and in response to the request, a dynamic grant or configured grant regarding sidelink resources; perform a clear channel assessment (CCA) procedure based on the dynamic grant or configured grant; select sidelink resources based on the CCA procedure and the dynamic grant or configured grant; and communicate with another UE 110-2 based on the sidelink resources. The first frequency band is a licensed frequency band and the second frequency band is an unlicensed frequency band.

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 2G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a Tx/Rx switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as Discontinuous Reception Mode (DRX) after a period of inactivity. During this state, the device 900 can power down for brief intervals of time and thus save power.

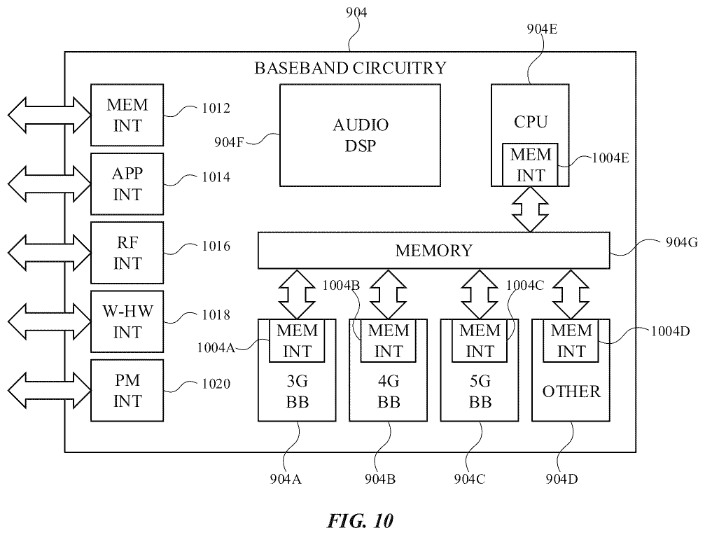

FIG. 10 is a diagram of example interfaces of baseband circuitry according to one or more implementations described herein. As discussed above, the baseband circuitry 904 of FIG. 9 can comprise processors 904A-904E and a memory 904G utilized by said processors. Each of the processors 904A-904E can include a memory interface, 1004A-1004E, respectively, to send/receive data to/from the memory 904G.

UEs 110 may use one or more components of FIG. 10 to perform one or more operations for processes described herein. For example, UE 110 may use one or more processors 904A-904E, memory interfaces 1004A-1004Es, and memory 904G to: communicate, to base station 122 via a first frequency band, a request for sidelink resource selection in a second frequency band; receive, from the base station and in response to the request, a dynamic grant or configured grant regarding sidelink resources; perform a clear channel assessment (CCA) procedure based on the dynamic grant or configured grant; select sidelink resources based on the CCA procedure and the dynamic grant or configured grant; and communicate with another UE 110-2 based on the sidelink resources. The first frequency band is a licensed frequency band and the second frequency band is an unlicensed frequency band.

The baseband circuitry 904 can further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912).

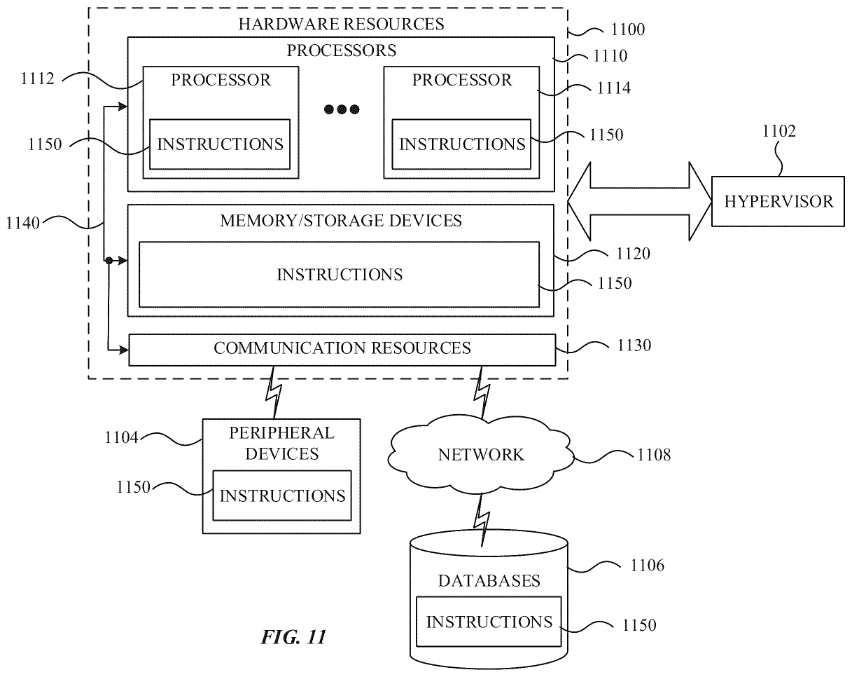

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140. For embodiments where node virtualization (e.g., NFV) is utilized, a hypervisor 1102 may be executed to provide an execution environment for one or more network slices/sub-slices to utilize the hardware resources 1100

UEs 110 and base station 122 may use one or more components of FIG. 11 to perform one or more operations for processes described herein. For example, processors 1110, instructions 1150, memory/storage device 1120, and communication resources 1130 may be used to: enable UE to communicate, to base station 122 via a first frequency band, a request for sidelink resource selection in a second frequency band; receive, from the base station and in response to the request, a dynamic grant or configured grant regarding sidelink resources; perform a clear channel assessment (CCA) procedure based on the dynamic grant or configured grant; select sidelink resources based on the CCA procedure and the dynamic grant or configured grant; and communicate with another UE 110-2 based on the sidelink resources. The first frequency band is a licensed frequency band and the second frequency band is an unlicensed frequency band.

The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1112 and a processor 1114.

The memory/storage devices 1120 may include main memory, disk storage, or any suitable combination thereof. The memory/storage devices 1120 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1130 may include interconnection or network interface components or other suitable devices to communicate with one or more peripheral devices 1104 or one or more databases 1106 via a network 1108. For example, the communication resources 1130 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband processor, of a user equipment (UE), may comprise one or more processors configured to: communicate, to a base station via a first frequency band, a request for sidelink resource selection in a second frequency band; receive, from the base station and in response to the request, a dynamic grant or configured grant regarding sidelink resources; perform a clear channel assessment (CCA) procedure based on the dynamic grant or configured grant; select sidelink resources based on the CCA procedure and the dynamic grant or configured grant; and communicate with another UE based on the sidelink resources. In example 2, which may also include one or more of the examples described herein, the first frequency band is a licensed frequency band and the second frequency band is an unlicensed frequency band.

In example 3, which may also include one or more of the examples described herein, the request for sidelink resource selection comprises a scheduling request (SR). In example 4, which may also include one or more of the examples described herein, the request for sidelink resource selection comprises a buffer status report (BSR). In example 5, which may also include one or more of the examples described herein, the configured grant comprises a type 1 configured grant or a type 2 configured grant. In example 6, which may also include one or more of the examples described herein, wherein the one or more processors are further configured to: communicate with the another UE via a physical sidelink control channel (PSCCH) and/or physical sidelink shared channel (PSSCH) upon a successful CCA procedure.

In example 7, which may also include one or more of the examples described herein, the one or more processors are further configured to: perform a sidelink Hybrid Automatic Repeat Request (HARQ) procedure for a shared channel occupancy time (COT). In example 8, which may also include one or more of the examples described herein, the one or more processors are further configured to: send, to the base station, an update of the sidelink resource selection. In example 9, which may also include one or more of the examples described herein, the one or more processors are further configured to: communicate the sidelink resource selection to UEs in an area. In example 10, which may also include one or more of the examples described herein, the one or more processors are further configured to: receive a sidelink resource configured grant retransmission from the base station.

In example 11, which may also include one or more of the examples described herein, a base station may comprise: a memory configured to store instructions; and one or more processors configured to execute the instructions to: receive, from a user equipment (UE) via a first frequency band, a request for sidelink resource selection in a second frequency band; and communicate, to the UE and in response to the request, a dynamic grant or a configured grant regarding sidelink resources, wherein the dynamic grant or the configured grant causes the UE to perform a clear channel assessment (CCA) procedure based on the dynamic grant or configured grant and select sidelink resources based on the CCA procedure and the dynamic grant or configured grant, and communicate with another UE based on the sidelink resources.

In example 11, which may also include one or more of the examples described herein, a sidelink Hybrid Automatic Repeat Request (HARQ) Acknowledgement (ACK) or HARQ Negative ACK (NACK) is received, from the UE, regarding sidelink communications with the another UE. In example 12, which may also include one or more of the examples described herein, a user equipment (UE) may comprise: a memory device configured to store instructions; and one or more processors configured to execute the instructions to: receive, from another UE, a sidelink communication via sidelink resources allocated to the another UE from a base station, the sidelink communication comprising information indicating sidelink resources reserved by the another UE for sidelink communications; communicating, to the another UE, a sidelink Hybrid Automatic Repeat Request (HARQ) Acknowledgement (ACK) or HARQ Negative ACK (NACK) based on whether the sidelink communication is received properly; and communicating, to other UEs, the information indicating the sidelink resources reserved by the another UE for sidelink communications.

In example 13, which may also include one or more of the examples described herein, the sidelink resources were reserved via dynamic grant or a configured grant from a base station via a first frequency band, and the sidelink communication was made via a second frequency band. In example 14, which may also include one or more of the examples described herein, the first frequency band is a licensed frequency band and the second frequency band is an unlicensed frequency band. In example 15, which may also include one or more of the examples described herein, the UE and the another UE communicate with one another via a physical sidelink control channel (PSCCH) and/or physical sidelink shared channel (PSSCH).

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, of a user equipment (UE), comprising:
a memory interface;
one or more processors coupled to the memory interface and configured to:
communicate, to a base station, a request for sidelink resource selection;
receive, from the base station and in response to the request, a dynamic grant or configured grant allocating sidelink resources;
perform a clear channel assessment (CCA) procedure in response to receiving the dynamic grant or configured grant;
select one or more sidelink resources based on the CCA procedure and the dynamic grant or configured grant; and
communicate with another UE based on the one or more sidelink resources.

2. The baseband processor of claim 1, wherein the request for sidelink resource selection is communicated via a licensed frequency band, and the one or more sidelink resources are in an unlicensed frequency band.

3. The baseband processor of claim 1, wherein the request for sidelink resource selection comprises a scheduling request (SR) or a buffer status report (BSR).

4. The baseband processor of claim 1, wherein the configured grant indicates a CCA type of the CCA procedure.

5. The baseband processor of claim-1 4, wherein the one or more processors are further configured to determine a channel access priority class based on the CCA type or another indication in the configured grant.

6. The baseband processor of claim 1, wherein the one or more processors are further configured to:
communicate with the another UE via a physical sidelink control channel (PSCCH) and/or physical sidelink shared channel (PSSCH) upon a successful CCA procedure.

7. The baseband processor of claim 1, wherein the one or more processors are further configured to:
perform a sidelink Hybrid Automatic Repeat Request (HARQ) procedure for a shared channel occupancy time (COT).

8. The baseband processor of claim 1, wherein the one or more processors are further configured to:
send, to the base station, an update of the sidelink resource selection.

9. The baseband processor of claim 1, wherein the one or more processors are further configured to:
communicate the sidelink resource selection to UEs in an area.

10. The baseband processor of claim 1, wherein the one or more processors are further configured to:
receive a sidelink resource configured grant retransmission from the base station.

11. A base station, comprising:
a memory configured to store instructions; and
one or more processors configured to execute the instructions to cause the base station to:
receive, from a user equipment (UE) via a first frequency band, a request for sidelink resource selection in a second frequency band; and
communicate, to the UE and in response to the request, a dynamic grant or a configured grant regarding sidelink resources,
wherein the dynamic grant or the configured grant causes the UE to perform a clear channel assessment (CCA) procedure based on the dynamic grant or configured grant and select sidelink resources based on the CCA procedure and the dynamic grant or the configured grant, and communicate with another UE based on the sidelink resources.

12. The base station of claim 11, wherein the first frequency band is a licensed frequency band and the second frequency band is an unlicensed frequency band.

13. The base station of claim 11, wherein the request for sidelink resource selection comprises a scheduling request (SR).

14. The base station of claim 11, wherein the request for sidelink resource selection comprises a buffer status report (BSR).

15. The base station of claim 11, wherein the configured grant comprises a type 1 configured grant or a type 2 configured grant.

16. The base station of claim 11, wherein a sidelink Hybrid Automatic Repeat Request (HARQ) Acknowledgement (ACK) or HARQ Negative ACK (NACK) is received, from the UE, regarding sidelink communications with the another UE.

17. A user equipment (UE), comprising:
a memory device configured to store instructions; and
one or more processors configured to execute the instructions to cause the UE to:
receive, from another UE, a sidelink (sidelink) communication via sidelink resources allocated to the another UE from a base station, the sidelink communication comprising information indicating sidelink resources reserved by the another UE for sidelink communications;
communicating, to the another UE, a sidelink Hybrid Automatic Repeat Request (HARQ) Acknowledgement (ACK) or HARQ Negative ACK (NACK) based on whether the sidelink communication is received properly; and
communicating, to other UEs, the information indicating the sidelink resources reserved by the another UE for sidelink communications.

18. The UE of claim 17, wherein the sidelink resources were reserved via dynamic grant or a configured grant from a base station via a first frequency band, and the sidelink communication was made via a second frequency band.

19. The UE of claim 18, wherein the first frequency band is a licensed frequency band and the second frequency band is an unlicensed frequency band.

20. The UE of claim 17, wherein the UE and the another UE communicate with one another via a physical sidelink control channel (PSCCH) and/or physical sidelink shared channel (PSSCH).
